(19) United States
(12) Patent Application Publication
(10) Pub. No.: US 2008/0277341 A1
(43) Pub. Date: Nov. 13, 2008

(54) Method for Making Reverse Osmosis Permeate Water and Mineral Water From Deep Seawater

(76) Inventors: Nai-Jen Huang, Gi-An Hsiang (TW); Chih-Cheng Lin, Gi-An Hsiang (TW); Chih-Shan Lin, Gi-An Hsiang (TW)

Correspondence Address: WHYTE HIRSCHBOECK DUDEK S C, 555 EAST WELLS STREET, SUITE 1900, MILWAUKEE, WI, 53202, US

(21) Appl. No.: 11/746,705

(22) Filed: May 10, 2007

(51) Int. Cl. C02F 9/06; C02F 1/44; C02F 1/469; C02F 1/58

(52) U.S. Cl. 210/637; 210/639; 210/641

(57) ABSTRACT

A method for making reverse osmosis permeate water and mineral water from deep seawater includes the steps of: a) sand-filtering or ultra-filtering the deep seawater; b) conducting a first nano-filtering step to nano-filter the deep seawater after the step a) to obtain first nano-filtration permeate water and first nano-filtration concentrated water; c) filtering the first nano-filtration permeate water using a reverse osmosis apparatus to obtain reverse osmosis permeate water and reverse osmosis concentrated water; and d) treating the first nano-filtration concentrated water by electrodialysis to obtain anion-rich water, cation-rich water, and mineral water.

### BACKGROUND OF THE INVENTION

1. Field of the Invention

The invention relates to a method for making reverse osmosis permeate water and mineral water, more particularly to a method for making reverse osmosis permeate water and mineral water from deep seawater with an improved efficiency.

2. Description of the Related Art

Conventionally, seawater is purified using distillation or membrane separation to separate the same into fresh water containing a relatively low level of salt and brine containing a relatively high level of salt. Since the cost for the membrane separation is relatively low, the membrane separation is used predominantly for purifying the seawater.

Referring to FIG. 1, a conventional method for producing pure water and mineral water from deep seawater comprises the steps of:

1) sand-filtering or ultra-filtering the deep seawater;

2) filtering the deep seawater after the step 1) using a reverse osmosis apparatus to obtain reverse osmosis permeate water and reverse osmosis concentrated water;

3) producing and packing pure drinking water from the reverse osmosis permeate water; and

4) treating the reverse osmosis concentrated water by electrodialysis to produce the mineral water.

Although the conventional method can be used to produce the pure water and the mineral water, it has the following disadvantages:

1) Since multi-valence ions (such as calcium ions, magnesium ions, and sulfate ions) contained in the deep seawater can not be removed therefrom by sand-filtering or by ultra-filtering, scaling and clogging problems attributed to such ions may occur in the reverse osmosis apparatus. Therefore, the quantity and quality of the reverse osmosis permeate water produced from the reverse osmosis apparatus are not satisfactory. Furthermore, the scaling and clogging problems may reduce the service life of the reverse osmosis apparatus, which in turn increases the production cost.

2) Since the reverse osmosis concentrated water obtained from the reverse osmosis apparatus contains a relatively high concentration of sodium ions, the cost for the electrodialysis treatment is relatively high.

### SUMMARY OF THE INVENTION

Therefore, the object of the present invention is to provide a method for making reverse osmosis permeate water and mineral water from deep seawater with an improved efficiency.

The method for making reverse osmosis permeate water and mineral water from deep seawater according to this invention includes the steps of: a) filtering the deep seawater using one of sand-filtering and ultra-filtering; b) conducting a first nano-filtering step to nano-filter the deep seawater after the step a) to obtain first nano-filtration permeate water and first nano-filtration concentrated water; c) filtering the first nano-filtration permeate water using a reverse osmosis apparatus to obtain reverse osmosis permeate water and reverse osmosis concentrated water; and d) treating the first nano-filtration concentrated water by electrodialysis to obtain anion-rich water, cation-rich water, and mineral water.

### BRIEF DESCRIPTION OF THE DRAWINGS

Other features and advantages of the present invention will become apparent in the following detailed description of the preferred embodiment with reference to the accompanying drawing, of which:

FIG. 1 is a flow diagram of a conventional method for producing pure water and mineral water from deep seawater;

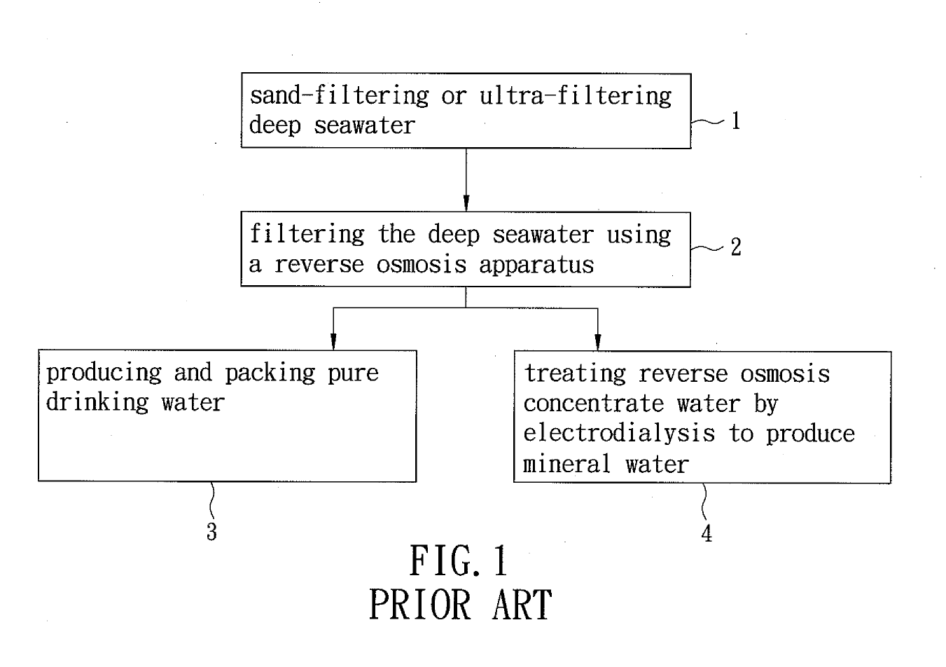

FIG. 2 is a flow diagram of the preferred embodiment of a method for making reverse osmosis permeate water and mineral water from deep seawater according to this invention; and

FIG. 3 is a schematic diagram of a system for realizing the method of the preferred embodiment.

### DETAILED DESCRIPTION OF THE PREFERRED EMBODIMENT

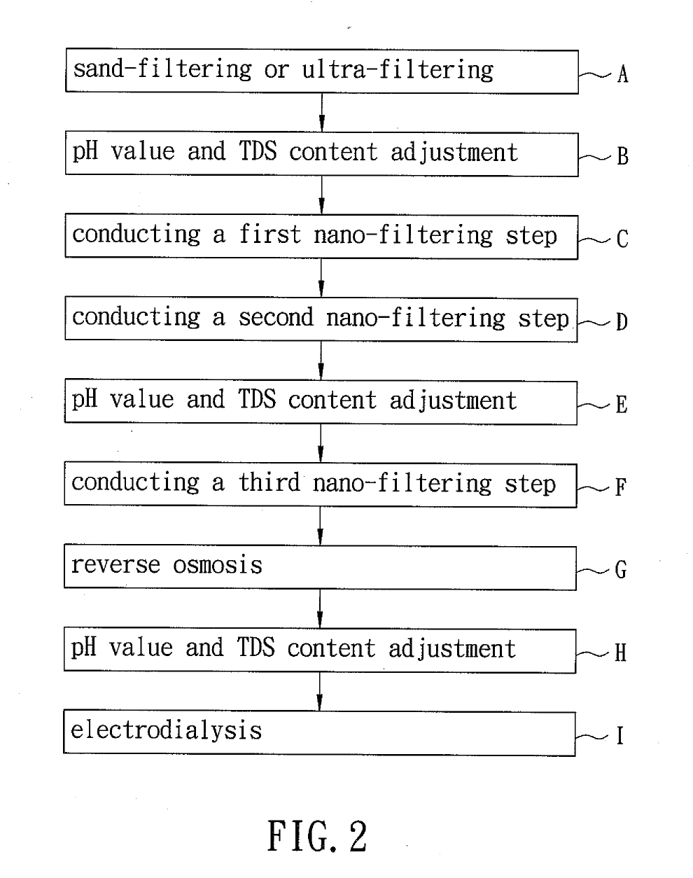

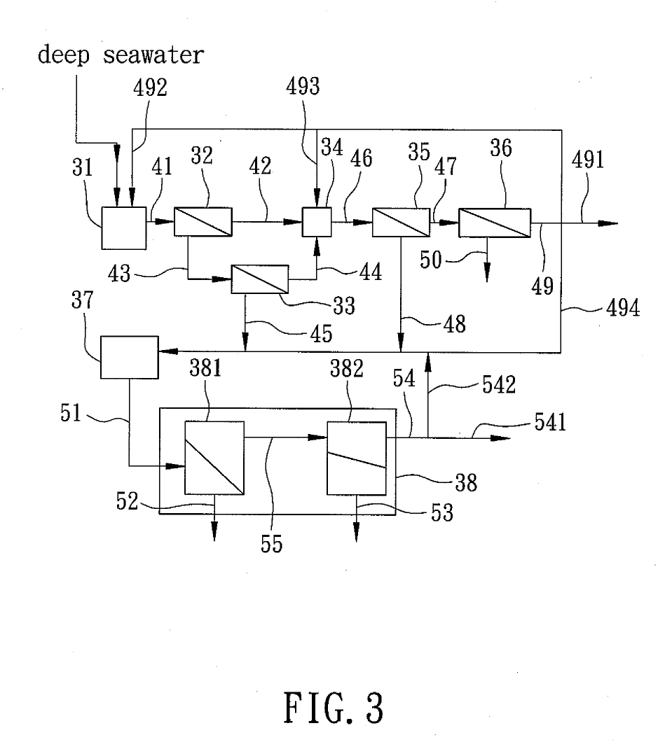

Referring to FIGS. 2 and 3, the preferred embodiment of the method for making reverse osmosis permeate water and mineral water from deep seawater according to this invention includes the steps of:

A) Sand-Filtering or Ultra-Filtering:

Deep seawater is preliminarily treated by sand-filtering or ultra-filtering to remove impurities, such as solid particulates, therefrom. The term “deep seawater” as used herein means sea water deeper than 200 meters below the sea level where photosynthesis cannot occur.

B) pH Value and TDS Content Adjustment:

The deep seawater after the step A) is directed to a first adjustment tank 31 to adjust pH value and total dissolved solid (hereinafter referred to as TDS) content of the deep seawater so as to obtain a first adjusted liquid 41 having proper pH value and TDS content.

C) Conducting a First Nano-Filtering Step:

The first adjusted liquid 41 is directed to a first nano-filtering apparatus 32 to conduct a first nano-filtering step so as to obtain first nano-filtration permeate water 42 and first nano-filtration concentrated water 43 which is rich in multi-valence ions, such as calcium, magnesium, and sulfate ions.

D) Conducting a Second Nano-Filtering Step:

The first nano-filtration concentrated water 43 is directed to a second nano-filtering apparatus 33 to conduct a second nano-filtering step so as to obtain second nano-filtration permeate water 44 and second nano-filtration concentrated water 45 which is rich in multi-valence ions, such as calcium, magnesium, and sulfate ions.

E) pH Value and TDS Content Adjustment:

The first and second nano-filtration permeate water 42,44 are directed to a second adjustment tank 34 where they are combined and adjusted in terms of the pH value and the TDS content so as to obtain a second adjusted liquid 46 having a proper pH value and TDS content.

F) Conducting a Third Nano-Filtering Step:

The second adjusted liquid 46 is directed to a third nano-filtering apparatus 35 to conduct a third nano-filtering step so as to obtain third nano-filtration permeate water 47 and third nano-filtration concentrated water 48 containing high concentration of multi-valence ions, such as calcium, magnesium, and sulfate ions.

G) Reverse Osmosis:

The third nano-filtration permeate water 47 is directed to a reverse osmosis apparatus 36 to conduct a reverse osmosis treatment so as to obtain reverse osmosis permeate water 49 and reverse osmosis concentrated water 50. Since the multi-valence ions, such as calcium, magnesium, and sulfate ions, are filtered into the first, second and third nano-filtration concentrated water 43, 45, 48 in the first, second and third nano-filtering steps, only single valence ions, such as sodium ions, are needed to be filtered out by the reverse osmosis apparatus 36. Thus, the scaling problem encountered in the prior art can be alleviated in the reverse osmosis apparatus 36. Therefore, the amount of the reverse osmosis permeate water 49 is increased, and the service life of the reverse osmosis apparatus 36 is extended.

The operating parameters for the reverse osmosis apparatus 36 primarily include feed pressure, recovery rate, and a material for a reverse osmosis membrane. The feed pressure preferably ranges from 700 to 1200 psi. The recovery rate of the reverse osmosis permeate water 49 preferably ranges from 20 to 80%. The suitable material for a reverse osmosis membrane is cellulose acetate or aromatic polyamide. The modular type for the reverse osmosis apparatus 36 may be tubular type, spiral wound type, plate-and-frame type or the like.

The reverse osmosis permeate water 49 is separated into a first portion 491 which is collected directly, a second portion 492 which is sent to the first adjustment tank 31 to adjust the TDS content of the deep seawater of the step B), a third portion 493 which is sent to the second adjustment tank 34 to adjust the TDS content of the nano-filtration permeate water in the second adjustment tank 34 of the step E), and a fourth portion 494 which is sent to a third adjustment tank 37.

H) pH Value and TDS Content Adjustment:

The second and third nano-filtration concentrated water 45, 48 and the fourth portion 494 of the reverse osmosis permeate water 49 are directed to the third adjustment tank 37 to obtain a third adjusted liquid 51 having proper pH value and TDS content.

I) Electrodialysis:

The third adjusted liquid 51 is directed to an electrodialysis apparatus 38 for electrodialysis treatment so as to obtain anion-rich water 52, cation-rich water 53, and mineral water 54.

The electrodialysis apparatus 38 includes an anion membrane electrodialysis unit 381 and a cation membrane electrodialysis unit 382 connected fluidly to each other. The anion membrane electrodialysis unit 381 is used to filter out sulfate ions from the third adjusted liquid 51 to obtain the anion-rich water 52, which is rich in sulfate ions, and electrodialysis permeate water 55, which is directed to the cation membrane electrodialysis unit 382. The cation membrane electrodialysis unit 382 is used to filter out sodium ions from the electrodialysis permeate water 55 to obtain the mineral water 54, which is rich in calcium and magnesium ions, and the cation-rich water 53, which is rich in sodium ions.

The mineral water 54 is separated into a first portion 541 which is collected directly, and a second portion 542 which is sent to the third adjustment tank 37 and which is combined with the second and third nano-filtration concentrated water 45, 48 and the fourth portion 494 of the reverse osmosis permeate water 49 to form the third adjusted liquid 51.

The operating parameters for each of the anion membrane electrodialysis unit 381 and the cation membrane electrodialysis unit 382 include an electric current ranging preferably from 2 to 70 A, a voltage ranging preferably from 10 to 80 V, and an electric conductivity ranging preferably from 5 to 70 mS/cm.

It should be noted that the first, second and third adjusted liquids 41, 46, 51 are formed in the first, second and third adjustment tanks 31, 34, 37, respectively before entering the first nano-filtering apparatus 32, the third nano-filtering apparatus 35, and the electrodialysis apparatus 38, respectively, so as to obtain better filtration effect. Preferably, the pH value for each of the first, second and third adjusted liquids 41, 46, 51 is adjusted to range from 3.0 to 11.0, and the TDS content for each of the first, second and third adjustment liquids 41, 46, 51 is adjusted to range from 5.0 to 70.0 g/L. The pH value may be adjusted by any suitable means well known in the art, such as by adding acid (e.g., sulfuric acid, nitric acid, and hydrochloric acid) or base (e.g., sodium hydroxide and potassium hydroxide). The TDS contents of the first, second and third adjusted liquids 41, 46, 51 are adjusted by adding the second and/or third nano-filtration concentrated water 45, 48, the second, third, and/or fourth portions 492, 493, 494 of the reverse osmosis permeate water 49, and/or the second portion 542 of the mineral water 54. If necessary, the aforesaid TDS content adjustments may be done in combination with distillation, evaporation, reverse osmosis concentration, dilution with water, or the like.

The ion separation ratios in the first, second and third nano-filtering apparatuses 32, 33, 35 may be controlled by adjusting the pH value and the TDS contents of the first, second, and third adjusted liquids 41, 46, 51 and the operating parameters of the first, second, and third nano-filtering apparatuses 32, 33, 35. The important operating parameters are the feed pressures in the first, second, and third nano-filtering apparatuses 32, 33, 35, and the recovery rates of the permeate water. The feed pressure preferably ranges from 50 to 750 psi. A preferable range of recovery rate for the nano-filtration permeate water 42, 44, 47 produced in the first, second and third nano-filtering apparatues 32, 33, 35 is 10-60%.

Additionally, each of the first, second and third nano-filtering apparatuses 32, 33, 35 may be composed of at least one nano-filtering cartridge. When each of the first, second and third nano-filtering apparatuses 32, 33, 35 is composed of a plurality of nano-filtering cartridges, the nano-filtering cartridges can be arranged in series, which can raise filtration efficiency, or in parallel, which can increase total water throughput.

The deep seawater usually has a pH value ranging from 6.0 to 8.0, and generally contains the following ions:

| | | |
|---|---|---|
| Chlorine ions: | 18,000–23,000 | mg/L |
| Sodium ions: | 8,000–10,000 | mg/L |
| Calcium ions: | 300–600 | mg/L |
| Magnesium ions: | 1,000–1,300 | mg/L |
| Sulfate ions: | 2,500–3,500 | mg/L |

This invention can produce a reverse osmosis permeate water having a low chlorine ion concentration of below 400 mg/L and a low sodium ion concentration of below 300 mg/L.

This invention can also produce a mineral water containing the following ions:

| | | |
|---|---|---|
| Chlorine ions: | 300–8,000 | mg/L |
| Sodium ions: | 200–5,000 | mg/L |
| Calcium ions: | 600–15,000 | mg/L |
| Magnesium ions: | 3,000–20,000 | mg/L |
| Sulfate ions: | 50–2,500 | mg/L |

The aforesaid concentrations reveal that the reverse osmosis permeate water and the mineral water produced by this invention can achieve the standard of drinking water.

### [Experimental Test]

In the following experimental tests, examples of this invention are compared with comparative examples of the conventional method. The examples of this invention are proceeded by ultra-filtering the deep sea water through a single ultra-filtering tube (Model No. FCS-DF50-4040), directing the deep seawater from the ultra-filtering tube through a single nano-filtering tube (Model No. FCS-TFC-4040) and then through a single reverse osmosis tube (Model No. FILMTEC SW30-4040) to obtain reverse osmosis permeate water. The comparative examples are proceeded by ultra-filtering the deep sea water through a single ultra-filtering tube (Model No. FCS-DF50-4040), and directing the deep seawater from the ultra-filtering tube to a single reverse osmosis tube (Model No. FILMTEC SW30-4040) to obtain reverse osmosis permeate water.

The following experimental results show the comparison of the water throughput and filtration efficiency of the present method and the conventional method that are obtained at specific reverse osmosis feed pressures and specific reverse osmosis recovery rates.

### [Experimental Results]

TABLE 1
The throughputs of the reverse osmosis permeate
water obtained under different feed pressures and at
the same recovery rate

| | | Feed pressure(psi) | | | | |
|---|---|---|---|---|---|---|
| | | 800 | 900 | 1000 | 1100 | 1200 |
| | | Recovery rate(%) | | | | |
| | | 20 | | | | |
| Throughput(L/min) | Comp.*¹ | 1.42 | 2.12 | 3.03 | 3.71 | 4.24 |
| | Ex.*² | 3.69 | 4.21 | 4.75 | 5.54 | 6.06 |

| | | | | | |
|---|---|---|---|---|---|
| Throughput ratio*³ | 2.60 | 1.99 | 1.57 | 1.49 | 1.43 |

*¹Comparative example
*²Example of this invention
*³The ratio of the throughput of Example to the throughput of Comparative example

TABLE 2
The throughputs of the reverse osmosis permeate
water at different recovery rates and under the same
feed pressure

| | | Feed pressure(psi) | | | | |
|---|---|---|---|---|---|---|
| | | 1000 | | | | |
| | | Recovery rate(%) | | | | |
| | | 10 | 20 | 30 | 40 | 50 |
| Throughput(L/min) | Comp.*¹ | 2.49 | 3.03 | 1.73 | 1.25 | — |
| | Ex.*² | — | 4.75 | 4.57 | 3.87 | 3.38 |

| | | | | | |
|---|---|---|---|---|---|
| Throughput ratio*³ | — | 1.57 | 2.64 | 3.10 | — |

*¹Comparative example
*²Example of this invention
*³The ratio of the throughput of Example to the throughput of Comparative example

TABLE 3
Quality of the reverse osmosis permeate water
produced at different recovery rates and under the same
feed pressure

| | | Feed pressure(psi) | | | | | |
|---|---|---|---|---|---|---|---|
| | | 1000 | | | | | |
| | | Recovery rate(%) | | | | | |
| | | 20 | | 30 | | 40 | |
| | | Comp.*¹ | Ex.*² | Comp. | Ex. | Comp. | Ex. |
| Filtration | Sulfate | 99.62 | 99.98 | 98.98 | 99.97 | 98.41 | 99.92 |
| efficiency | Na+ | 99.37 | 99.68 | 98.13 | 99.58 | 96.59 | 99.39 |
| (%) | K+ | 99.19 | 99.58 | 97.89 | 99.45 | 96.24 | 99.23 |
| | Ca+2 | 99.52 | 99.79 | 98.90 | 99.69 | 98.30 | 99.68 |
| | Mg+2 | 99.55 | 99.84 | 98.87 | 99.80 | 98.31 | 99.74 |

*¹Comparative example
*²Example of this invention

TABLE 4
Quality of the reverse osmosis permeate water
produced at different feed pressures and under the same
recovery rate

| | | Feed pressure(psi) | | | | | | | |
|---|---|---|---|---|---|---|---|---|---|
| | | 800 | | 900 | | 1000 | | 1100 | |
| | | Recovery rate(%) | | | | | | | |
| | | 20 | | | | | | | |
| | | Comp.*¹ | Ex.*² | Comp. | Ex. | Comp. | Ex. | Comp. | Ex. |
| Filtration | Sulfate | 99.05 | 99.95 | 99.49 | 99.98 | 99.62 | 99.98 | 99.68 | 99.92 |
| efficiency | Na+ | 98.38 | 99.45 | 99.10 | 99.57 | 99.37 | 99.68 | 99.42 | 99.72 |
| (%) | K+ | 98.16 | 99.13 | 98.88 | 99.36 | 99.19 | 99.58 | 99.32 | 99.62 |
| | Ca+2 | 99.01 | 99.72 | 99.38 | 99.81 | 99.52 | 99.79 | 99.58 | 99.77 |
| | Mg+2 | 99.00 | 99.79 | 99.40 | 99.83 | 99.55 | 99.84 | 99.61 | 99.84 |

*¹Comparative example
*²Example of this invention

It is shown in Table 1 that the throughput of the reverse osmosis permeate water in the examples of the present invention and the comparative examples is increased as the feed pressure increases at a constant recovery rate (20%). However, the throughput of the reverse osmosis permeate water of the example of the invention is greater than that of the comparative example at the same feed pressure and recovery rate.

It is shown in Table 2 that the throughput of the reverse osmosis permeate water in the examples of the present invention and the comparative example is decreased as the recovery rate increases at a constant feed pressure (1000 psi). However, the throughput of the reverse osmosis permeate water of the example of the invention is greater than that of the comparative example at the same feed pressure and recovery rate.

It is shown in Table 3 that when the recovery rate is increased at a constant feed pressure (1000 psi), the filtration efficiency of the comparative example is reduced, while the filtration efficiency of the example of the present invention is not affected and is maintained at a relatively high level (>99%). Also, the filtration efficiency of the example of the present invention is higher than that of the comparative example at the same feed pressure and recovery rate.

It is shown in Table 4 that the filtration efficiency of the comparative example increases as the feed pressure increases, while the filtration efficiency of the example of this invention is maintained stably at a higher level (>99%) without being affected by the feed pressure. Also, the filtration efficiency of the example of the present invention is higher than that of the comparative example at the same feed pressure and recovery rate.

It is noted that under the same unit of electrical power input, the comparative example provides a recovery rate of 20-30% for the reverse osmosis permeate water, while the recovery rate of the reverse osmosis permeate water of the example of the present invention can be increased to 45-50%.

In view of the aforesaid, the method of the present invention has the following advantages:

1. In the method of the present invention, one or more nano-filtering steps are used to obtain the nano-filtration concentrated water, which is rich in the multi-valence ions, such as sulfate, calcium, and magnesium ions, and the nano-filtration permeate water, which is rich in sodium ions and which contains small amounts of the multi-valence ions. Since the nano-filtration permeate water to be filtered in the reverse osmosis apparatus 36 contains small amounts of the multi-valence ions, the scaling and clogging problems encountered in the reverse osmosis apparatus used in the conventional method can be alleviated via this invention. Therefore, the throughput and the quality of the reverse osmosis permeate water obtained via the reverse osmosis treatment can be increased, and the service life of the reverse osmosis apparatus 36 used in the method of the present invention can be extended.

2. Since the nano-filtration concentrated water is rich in the multi-valence ions and contains small amounts of sodium ions, the production efficiency of the mineral water produced through the electrodialysis can be increased.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for making reverse osmosis permeate water and mineral water from deep seawater, comprising the steps of:
a) filtering the deep seawater using one of sand-filtering and ultra-filtering;
b) conducting a first nano-filtering step to nano-filter the deep seawater after the step a) to obtain first nano-filtration permeate water and first nano-filtration concentrated water;
c) filtering the first nano-filtration permeate water using a reverse osmosis apparatus to obtain reverse osmosis permeate water and reverse osmosis concentrated water; and
d) treating the first nano-filtration concentrated water by electrodialysis to obtain anion-rich water, cation-rich water, and mineral water.

2. The method as claimed in claim 1, further comprising a step of:
e) adjusting in a first adjustment tank the pH value and total dissolved solid content of the deep seawater after the step a) and before the step b).

3. The method as claimed in claim 2, further comprising a step of:
f) adjusting the pH value and the total dissolved solid content of the first nano-filtration permeate water in a second adjustment tank before the step c).

4. The method as claimed in claim 3, further comprising a step of:
g) adjusting the pH value and the total dissolved solid content of the first nano-filtration concentrated water in a third adjustment tank before the step d).

5. The method as claimed in claim 4, further comprising the steps of:
collecting directly a first portion of the reverse osmosis permeate water after the step (c);
sending a second portion of the reverse osmosis permeate water to the first adjustment tank to adjust the total dissolved solid content of the deep seawater of the step e);
sending a third portion of the reverse osmosis permeate water to the second adjustment tank to adjust the total dissolved solid content of the first nano-filtration permeate water of the step f); and
sending a fourth portion of the reverse osmosis permeate water to the third adjustment tank to adjust the total dissolved solid content of the first nano-filtration concentrated water of the step g).

6. The method as claimed in claim 1, wherein the step d) is conducted using an electrodialysis apparatus including an anion membrane electrodialysis unit and a cation membrane electrodialysis unit connected fluidly to each other.

7. The method as claimed in claim 6, wherein the anion membrane electrodialysis unit is used to filter sulfate ions from the first nano-filtration concentrated water to obtain the anion-rich water, and electrodialysis permeate water, and the cation membrane electrodialysis unit is used to filter sodium ions from the electrodialysis permeate water to obtain the mineral water and the cation-rich water.

8. The method as claimed in claim 4, further comprising the steps of:
collecting a first portion of the mineral water after the step d); and
sending a second portion of the mineral water to the third adjustment tank.

9. The method as claimed in claim 7, wherein each of the anion and cation membrane electrodialysis units has operating variables including an electric current ranging from 2 to 70 A, a voltage ranging from 10 to 80 V, and an electric conductivity ranging from 5 to 70 mS/cm.

10. The method as claimed in claim 4, further comprising the steps of:
conducting a second nano-filtering step to nano-filter the first nano-filtration concentrated water to obtain second nano-filtration permeate water and second nano-filtration concentrated water;
sending the second nano-filtration concentrated water to the third adjustment tank; and
recycling the second nano-filtration permeate water by sending the same to the second adjustment tank to combine with the first nano-filtration permeate water.

11. The method as claimed in claim 10, further comprising the steps of:
conducting a third nano-filtering step to nano-filter the first and second nano-filtration permeate water to obtain third nano-filtration permeate water and third nano-filtration concentrated water;
recycling the third nano-filtration permeate water by sending the same to the reverse osmosis apparatus; and
sending the third nano-filtration concentrated water to the third adjustment tank.

12. The method as claimed in claim 4, wherein the pH values are adjusted to range from 3.0 to 11.0 in the steps e), f) and g).

13. The method as claimed in claim 4, wherein the total dissolved solid contents are adjusted to range from 5.0 to 70.0 g/L in the steps e), f) and g).

14. The method as claimed in claim 11, wherein the first, second and third nano-filtering steps are conducted using a feed pressure ranging from 50 to 750 psi.

15. The method as claimed in claim 1, wherein the reverse osmosis apparatus is operated using a feed pressure ranging from 700 to 1200 psi.
